(19) United States
(12) Patent Application Publication
(10) Pub. No.: US 2008/0009977 A1
(43) Pub. Date: Jan. 10, 2008

(54) Apparatus and Method for Monitoring a Chemical-Supply System

(75) Inventors: Sowmya Krishnan, Newark, CA (US); Hubert Dinh, Hayward, CA (US)

Correspondence Address: PERKINS COIE LLP, P.O. BOX 2168, MENLO PARK, CA, 94026, US

(73) Assignee: ULTRA CLEAN HOLDINGS, Menlo Park, CA (US)

(21) Appl. No.: 11/775,776

(22) Filed: Jul. 10, 2007

Related U.S. Application Data
(60) Provisional application No. 60/819,836, filed on Jul. 10, 2006.

(51) Int. Cl. G05B 21/00

(52) U.S. Cl. 700/266

(57) ABSTRACT

The present invention provides a processing apparatus having multiple systems, and multiple components in each system. The apparatus includes a monitoring capability for monitoring the components and calculating a Health Index of each system, based on aggregate component performances of the components. The computer may initiate a trouble-shooting routine on components of a system if the Health Index of the system is below a preselected threshold value relative to a signature Health Index of the system. Also disclosed is a method for monitoring the performance characteristics of components in a multi-component chemical-delivery system.

This application claims the benefit of U.S. Provisional application Ser. No. 60/819,836, filed Jul. 10, 2006, which is incorporated in its entirety by reference herein.

### FIELD OF THE INVENTION

The present invention relates generally to the field of chemical delivery systems and more specifically to chemical delivery systems used in semiconductor processing equipment. The present invention relates to apparatuses and methods used to monitor these chemical delivery systems.

### BACKGROUND OF THE INVENTION

Advanced microelectronic devices are being manufactured with ever increasing device density and complexity. The device dimensions are decreasing in both the lateral and vertical directions. Smaller device elements allow for increasingly complex, faster, and more powerful devices. The multitude of layers and materials used in the construction of these advanced devices are being deposited by a number of well known techniques comprising low pressure thermal chemical vapor deposition (LPCVD), plasma enhanced chemical vapor deposition (PECVD), atmospheric pressure chemical vapor deposition (APCVD), physical vapor deposition (PVD), thermal conversion of the substrate, and the like.

Additionally, other well known techniques comprising etch, chemical mechanical polishing (CMP), ion implantation, electroplating, photoresist processing, and the like have also seen rapid development. Each of these techniques involves the controlled delivery of various chemical species in either a liquid or gaseous state to the substrate to facilitate the practice of the specific process method. Examples of suitable substrates comprise silicon wafers, gallium arsenide wafers, glass substrates as used in the manufacture of flat panel displays, “thin film head” substrates as used to manufacture memory disk drives for computers, substrates used in the manufacture of photonic devices, substrates used in the manufacture of micro-electro-mechanical systems (MEMS) devices, polymeric substrates as might be used for organic-based devices, and the like.

The high device density and small device dimensions are driving increasingly stringent requirements and specifications for the control, precision, repeatability, and reliability of chemical delivery subsystems used in semiconductor processing equipment. Small variations in the control, precision, and repeatability of the delivery of the various chemical species may have a profound effect on the quality, repeatability, and success of the process method. The repeatability and stability of the process method may be degraded if the component parts of the chemical delivery system degrade slowly over time. This may lead to degradation in the performance, yield, and quality of the device being manufactured. Long term, systematic changes in the performance of the component parts of the chemical delivery systems are difficult to identify, troubleshoot, and correct since the changes over time may be very small. Consequently, a large number of substrates may be processed before a significant error is identified. This may lead to some of these substrates being scrapped leading to an economic loss to the customer. Once a change in the performance of the chemical delivery system has been identified, it may be difficult to determine which component parts are responsible for the change. This may lead to long troubleshooting, maintenance, and non-productive times for the equipment.

Further, the processing apparatus may contain several, e.g., 5-10 systems, each with multiple components, making it difficult and laborious to systematically check the performance characteristics of each component of each system.

Therefore, a need exists in the art for apparatus and method for the readily monitoring, analysis, troubleshooting, and correction of components in the systems, including a chemical-delivery system, of a processing apparatus.

### SUMMARY OF THE INVENTION

In one aspect, the invention includes a processing apparatus intended for operation under specified processing conditions. The apparatus includes (a) a chemical-delivery system having a plurality of components that operate to deliver a defined fluid or fluids in the system, where the performance specifications of the components required for the intended operation of the apparatus are known or identified, (b) monitoring devices operatively connected to the system components for transmitting signals related to the performance of the components, (c) an interface operatively connected to the monitoring devices for receiving such signals, and (d) an electronic computer operatively connected to the interface and including (d1) a storage device for storing information about the performance characteristics of the components known or identified in (a), and (d2) a display device for displaying system performance information.

A machine readable storage medium capable of operation on the computer performs the steps of (i) calculating from information related to the performance-based signals received from the interface, a Health Index of the system based on an aggregate component performance, (ii) displaying the Health Index of the System, and (iii) initiating a trouble-shooting routine on components of the chemical-delivery system if the Health Index of the system is below a preselected threshold value relative to a signature Health Index of the system based on an aggregate component performance calculated from the performance characteristics known or identified in (a).

The signature Health Index provides a desired baseline performance metric for the system, against which changes in the system over time can be measured or calibrated. Thus, as long as the measured Health Index of the system is within a selected range of the signature, e.g., 96% of the signature HI, the system is judged to be functioning at a desired or optimal level consistent with the specified operation of the system, recognizing that different apparatus operations will require different performance capabilities.

The components of the chemical-delivery system may include a plurality of valved fluid controllers, and the performance characteristics of the valved components may be related to the response time and/or degree of opening of a valve. The chemical delivery system may be a gas panel for controlling and mixing gases from a plurality of sources.

The computer may calculate the Health Index as a linear combination of weighted component performance values.

The apparatus may include a plurality of such multi-component processing systems, and for each such system, monitoring devices for monitoring the system components, and the computer and machine-readable code may operate to calculate a Health Index for each such system.

In another aspect, the invention includes a method for identifying a problem component in a multi-system microfabrication apparatus intended for operation under specified processing conditions, where each system is composed of multiple components and the performance specifications of the components in each system required for the intended operation of the apparatus are known or identified. The method includes the steps of monitoring the performance of each component of the systems, using the monitored performance of each component to calculate, for each system, a Health Index of the system based on an aggregate component performance, and initiating a trouble-shooting routine on components of a system if the Health Index of that system is below a preselected threshold value relative to a signature Health Index of that system based on an aggregate component performance calculated from the performance characteristics known or identified, thus to identify one or more problem components.

One of the systems may be a chemical-delivery system, and the components of the system may include a plurality of valved fluid controllers.

Also disclosed is a system for monitoring chemical delivery system performance. The system includes one or more components within a chemical delivery system connected to a network; a computer connected to the network capable of receiving and storing component data transmitted across the network; a user interface for interacting with the computer; a computer readable medium containing procedures for acting upon the component data; and output devices for displaying the results of the procedure action upon the component data.

These and other objects and features of the invention will become more fully apparent when the following detailed description of the invention is read in conjunction with the accompanying drawings.

### BRIEF DESCRIPTION OF THE DRAWINGS

FIG. 1 is a schematic representation of a semiconductor process equipment system pertaining to some embodiments of the present invention.

FIG. 2 is a schematic representation of a chemical delivery system pertaining to some embodiments of the present invention.

FIG. 3 is a schematic representation of a single chemical path found within a chemical delivery system pertaining to some embodiments of the present invention.

FIG. 4 is an exemplary screen shot from the GUI from the computer system pertaining to some embodiments of the present invention.

FIG. 5 is a flow chart of some embodiments of the present invention.

FIG. 6 depicts an illustrative computer system pertaining to various embodiments of the present invention.

FIG. 7 depicts an illustrative system pertaining to various embodiments of the present invention.

### DETAILED DESCRIPTION OF THE INVENTION

After considering the following description, those skilled in the art will clearly realize that the teachings of the invention can be readily utilized in monitoring the performance of chemical delivery systems. As an example, chemical delivery systems used in semiconductor processing equipment will be used, but this is not intended to limit the scope of the present teaching in any way. Examples of semiconductor processing equipment comprise deposition systems, etch systems, CMP systems, ion implantation systems, electroplating systems, photoresist processing systems, and the like. In the following examples, a generic deposition system will be discussed, but this is not intended to limit the scope of the present teaching in any way.

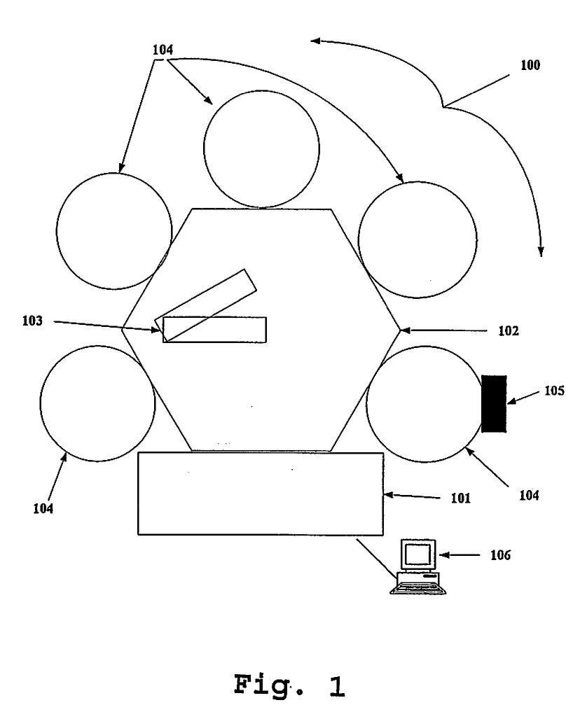

FIG. 1 is a schematic representation of a semiconductor process equipment apparatus pertaining to some embodiments of the present invention. This particular schematic illustrates a single wafer-processing apparatus wherein wafers are processed in each of the process modules, 104, one at a time. It will be appreciated by those skilled in the art that the present invention will be equally applicable to systems wherein a plurality of wafers is processed at the same time. These systems are typically called batch systems.

FIG. 1 schematically represents one embodiment of a semiconductor processing apparatus comprising a plurality of process chambers. In this figure, the semiconductor processing apparatus 100, is comprised of substrate handling subassembly, 101, transfer hub, 102, transfer robot, 103, a plurality of process chambers, 104, and a computer system, 106, to control the system. In some instances, each process module, 104, has a dedicated chemical delivery system, 105. For simplicity, only one chemical delivery system is illustrated in the figure, although apparatus 100 typically has a plurality of multi-components systems. It will be understood by those skilled in the art that each process chamber, 104, may have a dedicated chemical delivery system, 105. Alternatively, in rare cases, a single chemical delivery system may supply chemicals to all of the process modules, 104. This configuration has not been illustrated. Semiconductor process equipment may comprise any number of process chambers from one to eight or more. Additionally, other variations of this generic semiconductor process equipment may comprise other features and subassemblies not explicitly shown in this schematic. This exemplary representation does not limit the teaching of the present invention in any way.

A plurality of substrates is typically contained within a holder and is placed in the substrate handling subassembly, 101. Silicon wafers for use as substrates for the manufacture of semiconductor devices will be used as examples. However, the substrates may comprise compound semiconductors, flat panel displays, substrates for MEMS (micro electronic mechanical systems) devices, substrates for photonic devices, substrates for thin film head manufacture, polymers, ceramics, and the like. This exemplary use of silicon wafers does not limit the teaching of the present invention in any way. Typically, the wafers may be transferred from the cassette into one of the process chambers, 104, by transfer robot, 103, passing through transfer hub, 102. The transfer may occur at atmospheric pressure or may occur at a reduced pressure. The most common practice makes the transfer at a reduced pressure. In the case of transfer at a reduced pressure, there may be an intermediate loadlock chamber (not shown) between the substrate handling subassembly and the transfer hub or the substrate handling subassembly may have the ability to be evacuated to a reduced pressure. The specific process method associated with that process chamber is then practiced and the wafer may be returned to the cassette or may be transferred to another process chamber for the practice of additional process methods. Finally, the wafer is returned to the cassette and the cassette may be sent to the next processing system for additional steps in the manufacture of the devices. The operation of the apparatus is generally under the control of a computer 106. In the apparatus of the present invention, and as described below, computer 106 also functions to process performance-related signals from system components in the apparatus, for monitoring components and identifying problem components, in accordance with the invention.

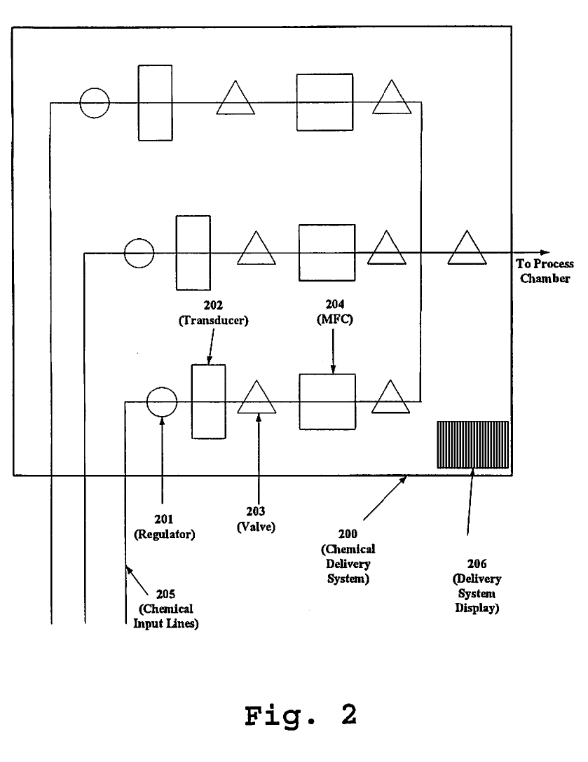

FIG. 2 is a schematic representation of a chemical delivery system pertaining to some embodiments of the present invention. Typically the chemical delivery system comprises an enclosure, 200, and there are one or more chemical input lines, 205, that enter the chemical delivery system. Typically, the chemical delivery system may comprise a local display, 206, used to display data from the chemical delivery system components. Three chemical input lines are shown in this illustration, but this does not limit the scope of the present invention in any way. Continuing to refer to FIG. 2, each chemical delivery line may comprise a regulator, 201, a pressure transducer, 202, one or more valves, 203, a control device, 204, (in this case a mass flow controller (MFC)), all connected with a conduit used to convey the chemicals from the input source (not shown) to the process chamber (not shown). For clarity, only one of the chemical delivery lines in FIG. 2 has been labeled. It is to be understood that similar symbol shapes correspond to similar components. FIG. 2 has been drawn very simply. It will be appreciated by those skilled in the art that typical chemical delivery systems may comprise many other lines, purge lines, drains, exhausts, other sensors, heaters, vaporizers, and the like. Additionally, FIG. 2 illustrates the three chemical delivery lines combining into a single conduit used to convey the chemicals to the process chamber. It will be appreciated by those skilled in the art that typical chemical delivery systems may also be designed wherein each chemical delivery line has a dedicated conduit to convey the chemical to the process chamber. This illustration does not limit the scope of the present invention in any way.

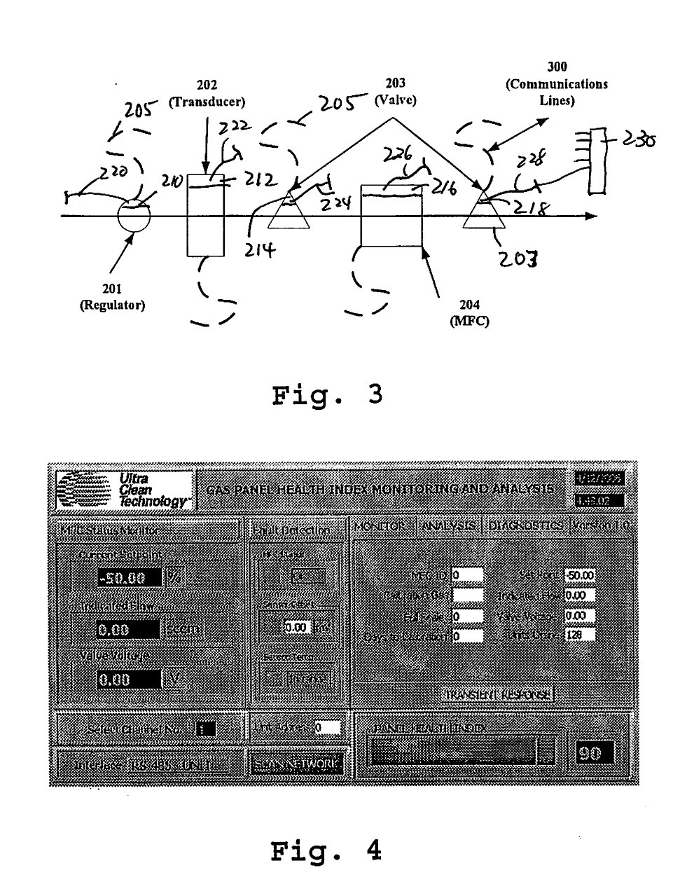

FIG. 3 is a schematic representation of a single chemical path found within a chemical delivery system pertaining to some embodiments of the present invention. Continuing to refer to FIG. 3, each chemical delivery line may comprise a regulator, 201, a pressure transducer, 202, one or more valves, 203, a control device, 204, (in this case a mass flow controller (MFC)), all connected with a conduit used to convey the chemicals from the input source (not shown) to the process chamber (not shown). In FIG. 3, a communications line, 205, has been added for each component in the chemical delivery line. This communications line may allow for the flow if data, setpoints, and commands between the components and the system computer (not shown). For clarity, only one of the communication lines in FIG. 3 has been labeled. It is to be understood that similar symbol shapes correspond to similar components. The communications lines may use typical communication interface protocols comprising RS-485, DeviceNet, Profinet, and the like. Also, each component has associated with a monitoring device, for transmitting signals

At least some of the components in the chemical-delivery system have associated therewith, a monitoring device, such as devices 210, 212, 214, 216, and 218, associated with components 201, 202, 203, 204, and 203, respectively, for monitoring the performance characteristics of the associated components, by generating signals related to the performance of the associated components. Such monitoring devices are well known in the gas panel field, and typically are incorporated into the component as an integral component, that is, supplied as an integral part of a commercially available component. The devices are designed to measure, for example response times and extent of openings of valve elements in valve elements of the components, in response to a given voltage input on the component, or measure temperature or pressure performance values associated with component operation. Associated with each monitoring device is a line connection, such as lines 220, 222, 224, 226, and 228, associated with devices 210, 212, 214, 216, and 218, respectively, for carrying signals from the monitoring devices to an interface 230 connected to computer 106, and which functions to convert the device signals to digital signals suitable for computer input.

In some embodiments of the present invention, the chemical delivery system may be a gas box. In the context of the present invention, the phrase “gas box” will be understood to convey its typical meaning in the art and may comprise an enclosure wherein many of the components used to control, measure, and flow the various gases used in the practice of the process method are housed. The gas box may also comprise vaporizer components wherein an input chemical is in a liquid form and is converted to a gaseous form before being conveyed to the process chamber. The phrase “gas box” is well known and will be understood by those skilled in the art.

The gas box may comprise a number of gas lines as illustrated in FIG. 2. The gas box serves to provide control, monitoring, and safety in the conveyance of the gases to the process chamber. The various components of the gas lines within the gas box may be under the control of the system computer, 106. The computer may command various valves to open and close in a specific sequence, may command a control device to meter a specific amount of gas for a specified amount of time, and the like. Additionally, the computer may receive signals from the components and other sensors within the gas box to verify that the operations were successful, the correct amount of gas flowed, and the like.

In some embodiments of the present invention, a software resource may be used for monitoring, analysis, and diagnosis of the performance of the entire gas box. The inventors will refer to this resource as a “Health Index Monitoring and Analysis (HIMA)” system. The HIMA system may reside on the system control computer and/or may reside on the engineer's remote computer if the system is connected to a suitable network. Examples of suitable networks comprise the Internet, a Local Area Network (LAN), a Wide Area Network (WAN), a wireless network, cellular networks (e.g. GSM, GPRS, etc.), combinations thereof, and the like.

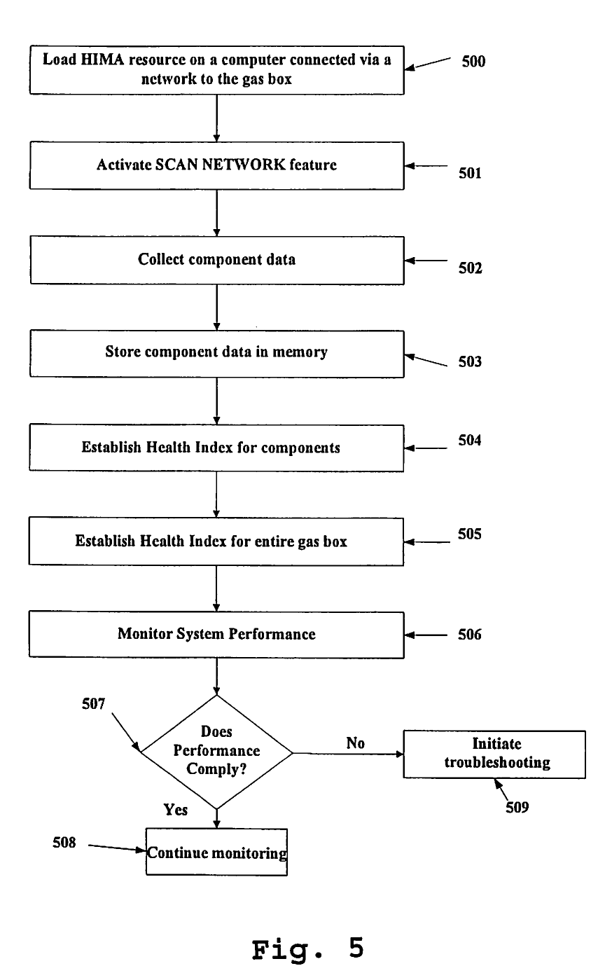

Typically, the HIMA system may comprise a graphical user interface (GUI) used to manage the human to machine interface and to display information comprising status, alerts, errors, setpoints for various components, actual flows for various gases, valve settings, offset parameters, communications information, and the like. An exemplary screen shot of one possible GUI display is illustrated in FIG. 4. The data may be displayed on the local gas box display, 206, the system control computer, 106, the computer on the engineer's desk (not shown), or any combination thereof. The HIMA system may collect and store parameters for each component within the gas box. As an example, some parameters for an MFC may comprise “Reported Flow” (flow units or % of full scale (FS) MFC range), “Valve Current” (mA), “Setpoint” (flow units or % FS), “Valve Voltage” (V), “Zero Offset” (mV) and the like. These values typically do not change dramatically with time during the practice of the process method. Additionally, the HIMA system may collect and store transient characteristics for each component within the gas box. As an example, some transient characteristics for an MFC may comprise “Overshoot” (% step change), “Undershoot” (% step change), “Accuracy” (% FS), “Control Time” (sec), “Settling Time” (sec), and the like.

In some embodiments of the present invention, the HIMA system is installed on the system computer and/or the engineer's remote computer. Typically, the communications network within the processing equipment exists and the various components within the gas box are connected to the network. The HIMA system has been designed to be hardware and component supplier agnostic in that it will work with all hardware and components that can communicate across one of the standard communication interface protocols. The user may select the specific communication interface protocol used by the specific processing equipment under consideration from a drop down menu on the GUI. The HIMA system comprises a “SCAN NETWORK” function that may scan the network, locate the components within the gas box, query their communications addresses, and populate the database fields. The “SCAN NETWORK” function may be activated at initial system start-up or may be activated at any other time such as after a component change or maintenance activity. The user may display the details of any component by selecting the channel number corresponding to the communications address of that component. If a component is selected during the practice of the process method, real-time data indicating the transient characteristics of the device may be displayed. The transient characteristics may be displayed numerically or graphically. Again, this feature may be activated from the GUI. These exemplary steps, 500-509, are illustrated in FIG. 5.

Typically, the HIMA system may be used to detect abrupt component failures. The user may set limits around important parameters and set flags for alert levels and error levels. The user may select a number of responses within the HIMA system if an alert or error condition is reached. Examples of responses may comprise sending an error signal to the system control computer, sending an email to the user, sending a page to the user, send a voice or text message to the user's cellular phone, displaying warning messages on the GUI, and the like.

In some embodiments of the present invention, the HIMA system may be used to detect errors and failure modes within the components that may be due to long term drift, loss of calibration, component degradation, and the like. The HIMA system may store and analyze data over long periods of time to detect slow, systematic failures or degradation in the components. The HIMA system may alert the user to components whose performance is degrading.

In some embodiments of the present invention, the HIMA system aggregates all of the data and may establish a “health index” (HI) for the components as well as for the entire gas box. The HI comprises at least one value that may be computed from the data received from the gas box components. The Hi for the gas box may be a weighted figure of merit based on all of the components within the gas box. Exemplary input data from each component into the establishment of the HI may comprise Accuracy, Control Time, Settling Time, Overshoot, Undershoot, Inlet Pressure, Gas temperature, Valve Voltage, Valve Current, Supply Voltage, Zero Offset, Leak By (when the setpoint=0), Valve Response Time, Current Sensor Offset, Reference Sensor Offset, Calibration Date, Calibration Due Date, Moisture Analysis Data, Rate-of-Rise Data, and the like. Each data point is given a numerical index if it is within a user defined range of the target value. The established HI for the entire gas box may be reported as a percentage (e.g. 90%) as illustrated in FIG. 4. The HI may be first established after the installation, calibration, and start-up of the system. This HI data point may serve as a baseline for future reference after the system has been in operation of long periods of time. Variations in the HI over time may indicate long term issues with the gas box that may need to be addressed to maintain the performance at a high level. These exemplary steps, 500-509, are illustrated in FIG. 5.

Typically, the supplier or customer may establish an algorithm to calculate the HI. In one example, the HI may be a linear combination of the weighted averages of the parameters described earlier, as well as others. One example is illustrated below:
HI=a(Accuracy)+b(Control Time)+c(Settling Time)+d(Overshoot)+e(Undershoot)+f(Inlet Pressure)+g(Gas temperature)+h(Valve Voltage)+i(Valve Current)+j(Supply Voltage)+k(Zero Offset)+l(Leak By (when the setpoint=0))

Where the coefficients a-l are values between 0 and 1 and the parameters are expressed as a percentage of their expected (desired or optimal) value. In this way, the HI value may be expressed as a percentage where 100% would represent the optimum health. Typically, the end user or customer may select the coefficients such that those parameters that are of primary importance are emphasized. This algorithm is used for illustrative purposes only and does not limit the present invention in any way. It will be appreciated by those skilled in the art that the algorithm may be tailored by the user to highlight, track, and report those data that are of particular importance for the specific process method being practiced.

Typically, an HI value may be computed for each chemical delivery line within the gas box to track the performance of individual lines and to facilitate the troubleshooting and maintenance of the chemical delivery system. Therefore, another algorithm for calculating the HI for the entire chemical delivery system may comprise some combination of the HI values for each chemical delivery line. Those skilled in the art will appreciate the value of this capability.

Typically, the HIMA system may advantageously exploit the stored data and the HI to aid in the troubleshooting and diagnosis of gas boxes that are performing poorly. The HIMA system may shorten the troubleshooting time by indicating to the service personnel the identity of those systems having suboptimal HI, and within that system, the identity of components that may have sub par performance values. The diagnostics features of the HIMA system may be loaded with routine failures and corrective actions and may be queried by the service personnel during the troubleshooting activity. This may shorten the time for troubleshooting and maintenance, increase the overall equipment uptime, and provide increased economic value to the customer through improved overall equipment efficiency (OEE).

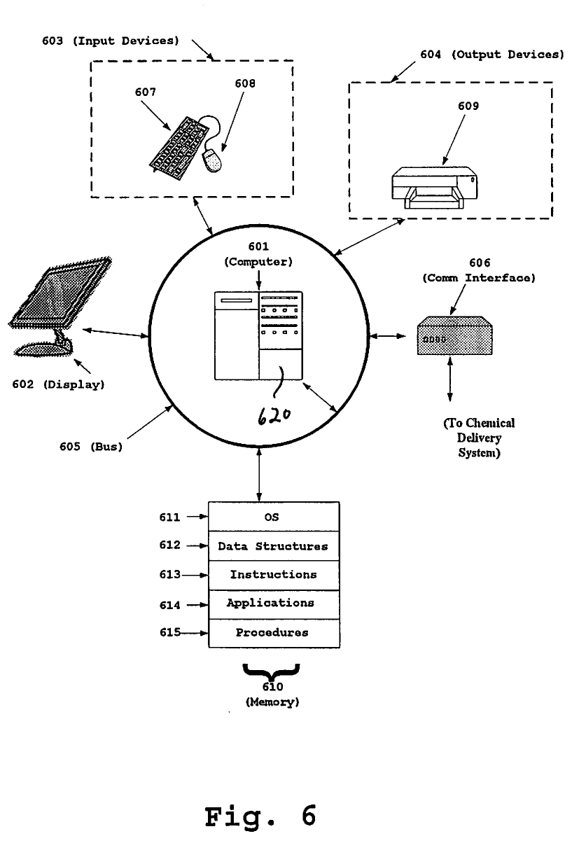

FIG. 6 depicts an illustrative computer system pertaining to various embodiments of the present invention. In some embodiments, the computer system comprises a computer 601, display, 602, one or more input interfaces, 603, communications interface, 606, and one or more output interfaces, 604, all conventionally coupled by one or more buses, 605. The computer, 601, comprises one or more processors (not shown) and one or more memory modules, 610. The computer itself includes a conventional storage device 620 for storing information about the performance characteristics of the system components. As noted about, these performance characteristics are those required for achieving a desired operation.

The input interfaces, 603, may comprise a keyboard, 607, and a mouse, 60, selected operating mode in the system, and include, for example, value response time and percent opening in response to given voltage inputs. These “optimal” values are then used to calculate a signature Health Index for the system, and it is against this signature HI that changes in the HI of the system, as the performance of one or more components changes, that the HI of the system is reported; for example, a 70% HI indicates a HI that is 70% of the signature HI determined as above.

The output interface, 604, may comprise a printer, 609. The communications interface, 606, is a network interface that allows the computer system to communicate via a wireless or hardwired network as previously described.

The memory modules, 610, generally comprise different modalities, illustratively semiconductor memory, such as random access memory (RAM), and disk drives as well as others. In various embodiments, the memory modules, 610, store an operating system, 611, collected data, 612, instructions, 613, applications, 614, and procedures, 615.

In various embodiments, the specific software instructions, data structures and data that implement various embodiments of the present invention are typically incorporated in the computer, 601, and are referred to herein as machine-readable storage medium. Generally, an embodiment of the present invention is tangibly embodied in a computer readable medium, for example, the memory and is comprised of instructions, applications, and procedures which, when executed by the processor, causes the computer system to utilize the present invention, for example, the collection, aggregation, and analysis of data, establishing benchmark metrics for performance, comparing performance data to the benchmark metrics, displaying the results of the analyses, and the like. The memory may store the software instructions, data structures, and data for any of the operating system, the data collection application, the data aggregation application, the data analysis procedures, and the like in semiconductor memory, in disk memory, or a combination thereof.

Specifically, the computer readable medium capable of operation on said computer to perform the steps of:

(i) calculating from information related to said performance-based signals received from said interface, a Health Index of the system based on an aggregate component performance,

(ii) displaying the Health Index of the System, and

(iii) initiating a trouble-shooting routine on components of the chemical-delivery system if the Health Index of the system is below a preselected threshold value relative to a signature Health Index of the system based on an aggregate component performance calculated from the performance characteristics known or identified in (a).

As discussed above, step (i) includes receiving input data signals on components in the system, converting each of the signals to a weighted performance metric, e.g., a percent of the desired “signature” performance, and using the aggregate date to construct a Health Index for the System at that point in time.

Step (ii) is simply displaying the Health index for the system on the display monitor. Typically, the display will include the HI for each system in the apparatus, so that the user can readily identify any system that is operating at a sub par level, or the display may include only HI information about those systems that are operating sub par.

Step (iii), initiating a trouble-shooting routine, involves deconvoluting the HI for a given sub par system, to identify one or more components whose sub par performance is responsible for the sub par HI. This can be done readily, for example, by determining the weighted performance characteristic of each component in the system, and identifying those components whose weighted values are most heavily contributing to the sub par HI score.

The operating system may be implemented by any conventional operating system comprising Windows® (Registered trademark of Microsoft Corporation), Unix® (Registered trademark of the Open Group in the United States and other countries), Mac OS® (Registered trademark of Apple Computer, Inc.), Linux® (Registered trademark of Linus Torvalds), as well as others not explicitly listed herein.

In various embodiments, the present invention may be implemented as a method, system, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over the network.

The article of manufacture in which the code is implemented also encompasses transmission media, such as the network transmission line and wireless transmission media. Thus the article of manufacture also comprises the medium in which the code is embedded. Those skilled in the art will recognize that many modifications may be made to this configuration without departing from the scope of the present invention.

The exemplary computer system illustrated in FIG. 6 is not intended to limit the present invention. Other alternative hardware environments may be used without departing from the scope of the present invention.

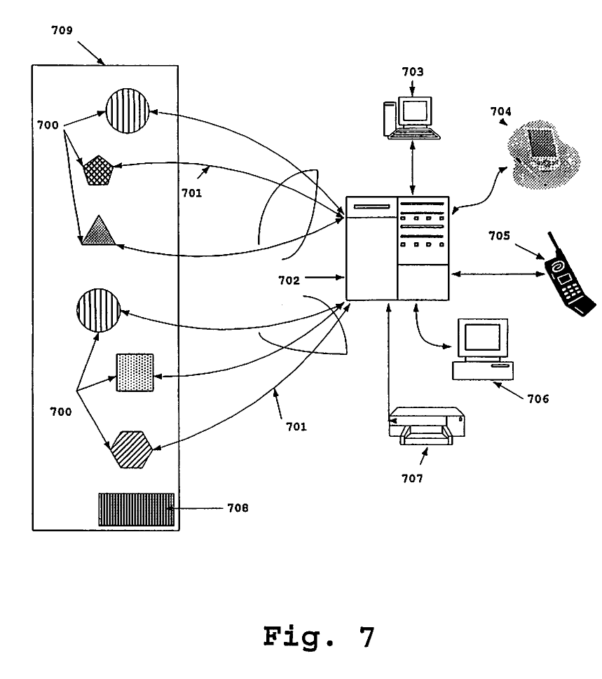

Referring now to FIG. 7, the methods of some embodiments of the present invention may be implemented on a plurality of systems. The systems may comprise one or more sensors or components, 700, a network for transmitting the data to a computer, 701, a computer for receiving and storing data from the plurality of components, 702, user interfaces for interacting with the computer, 703-706, procedures for acting upon the data, and a plurality of output devices for displaying the results of the procedure action, 703-708. The chemical delivery system is illustrated as 709.

Continuing to refer to FIG. 7, in some exemplary embodiments comprising gas boxes, the sensors contained within the components may monitor various settings and performance attributes. The data may be communicated onto a network, 701. Examples of suitable networks comprise the Internet, a Local Area Network (LAN), a Wide Area Network (WAN), a wireless network, a satellite network, cellular networks (e.g. GSM, GPRS, etc.), combinations thereof, and the like. The data may be received and stored on a computer, 702. The data in the computer may be accessed by a plurality of user interfaces comprising computer terminals, 706, personal computers (PCs), 706, personal digital assistants (PDAs), 704, cellular phones, 705, local displays, 708, interactive displays, and the like. This allows the user to be located remotely from the centralized database. Procedures may be used to act on the data to generate Health Indices. The procedures may be part of a standard set of calculations or may be developed and generated by the user. The results of the action by the procedures may be displayed to the user on a number of output means. Examples of suitable output means comprise computer terminals, 704, personal computers (PCs), 706, printers, 707, LED displays, personal digital assistants (PDAs), 704, cellular phones, 705, interactive displays, local displays, 708, and the like.

Although various embodiments which incorporate the teachings of the present invention have been shown and described in detail herein, those skilled in the art can readily devise many other varied embodiments that still incorporate these teachings.

What is claimed is:

1. Processing apparatus intended for operation under specified processing conditions, comprising
(a) a chemical-delivery system having a plurality of components that operate to deliver a defined fluid or fluids in the system, where the performance specifications of the components required for the intended operation of the apparatus are known or identified, for transmitting signals related to the performance of said components,
(b) monitoring devices operatively connected to the system components for transmitting signals related to the performance of the components,
(c) an interface operatively connected to said monitoring devices for receiving such signals,
(d) an electronic computer operatively connected to said interface and including:
(d1) a storage device for storing information about the performance characteristics of the components known or identified in (a), and
(d2) a display device for displaying system performance information, and
(e) machine-readable storage medium capable of operation on said computer to perform the steps of:
(ei) calculating from information related to said performance-based signals received from said interface, a Health Index of the system based on an aggregate component performance,
(eii) displaying the Health Index of the System, and
(eiii) initiating a trouble-shooting routine on components of the chemical-delivery system if the Health Index of the system is below a preselected threshold value relative to a signature Health Index of the system based on an aggregate component performance calculated from the performance characteristics known or identified in (a).

2. The apparatus of claim 1, wherein the components of the system include a plurality of valved fluid controllers, and said performance characteristics of the valved components are related to the response time and/or degree of opening of a valve.

3. The apparatus of claim 2, wherein said chemical delivery system is a gas panel for controlling and mixing gases from a plurality of sources.

4. The apparatus of claim 1, wherein said computer calculates the Health Index as a linear combination of weighted component performance values.

5. The apparatus of claim 1, having a plurality of multi-component processing systems, and for each such system, monitoring devices for monitoring the system components, and said computer and machine-readable code is operable to calculate a Health Index for each such system.

6. A method for identifying a problem component in a multi-system microfabrication apparatus intended for operation under specified processing conditions, where each system is composed of multiple components and the performance specifications of the components in each system required for the intended operation of the apparatus are known or identified, said method comprising
monitoring the performance of each component of the systems,
using the monitored performance of each component to calculate, for each system, a Health Index of the system based on an aggregate component performance, and
initiating a trouble-shooting routine on components of a system if the Health Index of that system is below a preselected threshold value relative to signature Health Index of that system based on an aggregate component performance calculated from the performance characteristics known or identified, thus to identify one or more problem components.

7. The method of claim 6, wherein one of said systems is a chemical-delivery system, and the components of the system include a plurality of valved fluid controllers.

8. Apparatus for monitoring chemical delivery system performance comprising:
one or more components within a chemical delivery system connected to a network;
a computer connected to said network capable of receiving and storing component data transmitted across said network;
a user interface for interacting with said computer;
a computer readable medium containing procedures for acting upon said component data; and
output devices for displaying the results of said procedure action upon said component data.

9. The apparatus of claim 8 wherein said chemical delivery system is a gas box.

10. The apparatus of claim 8 wherein said chemical delivery system is a liquid delivery system.

11. The apparatus of claim 8 wherein said procedures comprise:
procedures for establishing a Health Index for said components; and
procedures for establishing a Health Index for said chemical delivery system.
